(19) United States
(12) Patent Application Publication
(10) Pub. No.: US 2022/0019195 A1
(43) Pub. Date: Jan. 20, 2022

(54) ROBOTIC PROCESS AUTOMATION WITH CONVERSATIONAL USER INTERFACE

(71) Applicant: Automation Anywhere, Inc., San Jose, CA (US)

(72) Inventors: Yongke Yu, Hayward, CA (US); Sendam Ravikumar, Santa Clara, CA (US); Virinchipuram Anand, San Ramon, CA (US); Abhijit Kakhandiki, San Jose, CA (US); Peter Meechan, Pleasanton, CA (US)

(21) Appl. No.: 16/930,247

(22) Filed: Jul. 15, 2020

(51) Int. Cl. G05B 19/4155; B25J 9/16

(52) U.S. Cl. CPC G05B 19/4155; B25J 9/1658; G05B 2219/50391; B25J 9/161; B25J 9/1661

(57) ABSTRACT

Robotic process automation (RPA) systems with improved user access enable a user to interact with an RPA system by way of a communication platform. The communication platform can support text messaging and/or speech communication with a virtual agent that in turn is able to interface with an RPA system. In this way, a user of the communication platform is able to conveniently interact with the RPA system, such as in a conversational manner. By analyzing and interpreting the conversation, the user's intent or desire can be determined and then carried out by the RPA system. Thereafter, results from the RPA system can be formatted and returned to the user. In one embodiment, to better understand the user's intent or desire from the text messages or natural language communications (i.e., voice or speech communications), artificial intelligence can be used.

### BACKGROUND OF THE INVENTION

Robotic process automation (RPA) systems enable automation of repetitive and manually intensive computer-based tasks. In an RPA system, a computer software, namely a software robot (often referred to as a “bot”), may mimic the actions of a human being in order to perform various computer-based tasks. For instance, an RPA system can be used to interact with one or more software applications through user interfaces, as a human being would do. Therefore, RPA systems typically do not need to be integrated with existing software applications at a programming level, thereby eliminating the difficulties inherent to integration, namely bringing together diverse components. Advantageously, RPA systems permit the automation of application level repetitive tasks via software robots that are coded to repeatedly and accurately perform the repetitive task.

RPA systems have their own graphical user interface to create, manage and execute software robots. Unfortunately, however, these graphical user interfaces serve a lot of functions that are not immediately accessible or readily understood by many users. Therefore, there is a need for improved approaches to access capabilities of RPA systems with increased efficiency and less domain knowledge.

### SUMMARY

Embodiments disclosed herein concern improved access to robotic process automation (RPA) systems. A user may interact with an RPA system by way of a communication platform. In one embodiment, the communication platform supports text messaging and/or natural language communications (i.e., voice or speech communications) with a virtual agent that interfaces with the RPA system. The user can communicate with the virtual agent using a conversational-based user interface. In this way, a user of the communication platform is able to conveniently interact with the RPA system, such as in a conversational manner. For example, a user can induce an action by the RPA system through use of one or more text messages or through use of natural language communications. By analyzing and interpreting the conversation, the user's intent or desire can be determined and carried out by the RPA system. Thereafter, results from the RPA system can be formatted and returned to the user via the conversational-based user interface or other means.

In one embodiment, to better understand the user's intent or desire from text-based messages or natural language communications (i.e., voice or speech communications), artificial intelligence can be used. Once the user's intent or desire with respect to an RPA system is estimated, then an appropriate software automation process supported by the RPA system can be determined and utilized.

The invention can be implemented in numerous ways, including as a method, system, device, apparatus (including computer readable medium and graphical user interface). Several embodiments of the invention are discussed below.

As a computer-implemented method for providing software automation, one embodiment can, for example, include at least: examining a conversation provided in a communication platform for a software automation objective; retrieving a virtual agent automation dialog relevant to the software automation objective; initiating presentation of the virtual agent automation dialog within the communication platform to acquire configuration parameters; and activating a software automation process in accordance with the configuration parameters to provide the software automation objective.

Optionally, the communication platform can be a unified communication platform supporting text and voice/speech communications. The communication platform can also be a unified communication and collaboration platform. The virtual agent automation dialog can comprise a chat session between the virtual agent and a user, wherein the chat session includes a plurality of text messages. Furthermore, the computer-implemented method can also identify the software automation process to be activated from a plurality of available software automation processes based on the software automation objective or the virtual agent automation dialog.

As a computer-implemented method for providing software automation, another embodiment can, for example, include at least: examining a conversation provided in a communication platform for a software automation objective; identifying a software automation process associated with the software automation objective; retrieving a parameter set for the identified software automation process; forming at least one dialog message to request parameter data for the parameter set for the identified software automation process; inserting the at least one dialog message into the conversation provided in the communication platform; examining the conversation provided in the communication platform for a response to the at least one dialog message; extracting the parameter data from the response to the at least one dialog message; and requesting execution of the identified software automation process in accordance with the parameter data from the response to the at least one dialog message.

As a computer-implemented system for facilitating conversational user interaction between a communication platform and a robotic process automation system, one embodiment can, for example, include at least: a communication platform interface to receive communication within the communication platform associated with a virtual digital assistant; an artificial intelligence (AI) platform interface to provide the received communication to an AI evaluation platform and to receive evaluation feedback from the AI evaluation platform; a plurality of dialogs used with or by the virtual digital assistant to support user access to the robotic process automation system; and a conversational control module. The conversational control module can be configured to: provide the received communication, received via the communication platform interface, to the AI platform interface; receive the evaluation feedback from the AI platform interface; select at least one dialog from the plurality of dialogs based on evaluation feedback; identify a software automation process associated with the received communication, the evaluation feedback and/or the selected dialog; invoke the selected dialog with or by the virtual digital assistant to acquire user parameter data for use with the identified software automation process; and activate the identified software automation process based on at least a portion of the acquired user parameter data.

As a non-transitory computer readable medium including at least computer program code tangible stored thereon for providing software automation, one embodiment can, for example, include at least: computer program code for examining a conversation provided in a communication platform for a software automation objective; computer program code for retrieving a virtual agent automation dialog relevant to the software automation objective; computer program code for initiating presentation of the virtual agent automation dialog within the communication platform to acquire configuration parameters; and computer program code for activating a software automation process in accordance with the configuration parameters to provide the software automation objective.

As a non-transitory computer readable medium including at least computer program code tangible stored thereon for providing software automation, another embodiment can, for example, include at least: computer program code for examining a conversation provided in a communication platform for a software automation objective; computer program code for identifying a software automation process associated with the software automation objective; computer program code for retrieving a parameter set for the identified software automation process; computer program code for forming at least one dialog message to request parameter data for the parameter set for the identified software automation process; computer program code for inserting the at least one dialog message into the conversation provided in the communication platform; computer program code for examining the conversation provided in the communication platform for a response to the at least one dialog message; computer program code for extracting the parameter data from the response to the at least one dialog message; and computer program code for requesting execution of the identified software automation process in accordance with the parameter data from the response to the at least one dialog message.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like elements, and in which:

FIG. 1 is a conversational robotic process automation control system according to one embodiment.

FIG. 2 is a flow diagram of a conversational software automation process according to one embodiment.

FIGS. 3A and 3B are flow diagrams of a conversational automation process according to another embodiment.

FIG. 4 is a status message process according to one embodiment.

FIGS. 5A and 5B illustrate flow diagrams of a conversational automation process according to another embodiment.

FIG. 6 is a screen depiction of an exemplary graphical user interface providing a virtual agent operating in a communication platform, according to one embodiment.

FIG. 7 is a screen depiction of an exemplary graphical user interface indicating some capabilities of a virtual agent operating in a communication platform, according to one embodiment.

FIG. 8 is a screen depiction of an exemplary graphical user interface indicating a prior request and a series of conversational requests and responses, according to one embodiment.

FIG. 9 is a screen depiction of an exemplary graphical user interface indicating status data concerning performance of a software automation process, according to one embodiment.

FIG. 10 is a block diagram of a robotic process automation (RPA) system according to one embodiment.

FIG. 11 is a block diagram of a generalized runtime environment for bots in accordance with another embodiment of the RPA system illustrated in FIG. 10.

FIG. 12 illustrates yet another embodiment of the RPA system of FIG. 10 configured to provide platform independent sets of task processing instructions for bots.

FIG. 13 is a block diagram illustrating details of one embodiment of the bot compiler illustrated in FIG. 12.

FIG. 14 illustrates a block diagram of an exemplary computing environment for an implementation of an RPA system, such as the RPA systems disclosed herein.

### DETAILED DESCRIPTION OF CERTAIN EMBODIMENTS

Embodiments disclosed herein concern improved access to RPA systems. A user may interact with an RPA system by way of a communication platform. In one embodiment, the communication platform supports text messaging and/or natural language communications (i.e., voice or speech communications) with a virtual agent that interfaces with the RPA system. The user can communicate with the virtual agent using a conversational-based user interface. In this way, a user of the communication platform is able to conveniently interact with the RPA system, such as in a conversational manner. For example, a user can induce an action by the RPA system through use of one or more text messages or through use of natural language communications. By analyzing and interpreting the conversation, the user's intent or desire can be determined and carried out by the RPA system. Thereafter, results from the RPA system can be formatted and returned to the user via the conversational-based user interface or other means.

In one embodiment, to better understand the user's intent or desire from the text messages or natural language communications (i.e., voice or speech communications), artificial intelligence can be used. Once the user's intent or desire with respect to an RPA system is estimated, then an appropriate software automation process supported by the PRA system can be determined and utilized. Advantageously, users are able to interact with RPA systems using a conversational style that is readily understood by users.

Generally speaking, RPA systems use computer software to emulate and integrate the actions of a human interacting within digital systems. In an enterprise environment, these RPA systems are often designed to execute a business process. In some cases, the RPA systems use AI and/or other machine learning capabilities to handle high-volume, repeatable tasks that previously required humans to perform. The RPA systems support a plurality of software automation processes (SAPs). The RPA systems also provide for creation, configuration, management, execution, monitoring, and performance of software automation processes.

A software automation process can also be referred to as a software robot, software agent, or a bot. A software automation process can interpret and execute tasks on your behalf. Software automation processes are particularly well suited for handling a lot of the repetitive tasks that humans perform every day. Software automation processes can perform a task or workflow they are tasked with once or 10,000 times and do it accurately every time. As one example, a software automation process can locate and read data in a document, email, file, or window. As another example, a software automation process can connect with one or more Enterprise Resource Planning (ERP), Customer Relations Management (CRM), core banking, and other business systems to distribute data where it needs to be in whatever format is necessary. As another example, a software automation process can perform data tasks, such as reformatting, extracting, balancing, error checking, moving, copying, etc. As another example, a software automation process can grab data desired from a webpage, application, screen, file, or other data source. As still another example, a software automation process can be trigger based on time or an event, and can serve to take files or data sets and move them to another location, whether it is to a customer, vendor, application, department or storage. These various capabilities can also be used in any combination. As an example of an integrated software automation process, the software automation process can start a task or workflow based on a trigger, such as a file being uploaded to an FTP system. The integrated software automation process can then download that file, scrape relevant data from it, upload the relevant data to a database, and then send an email to inform the recipient that the data has been successfully processed.

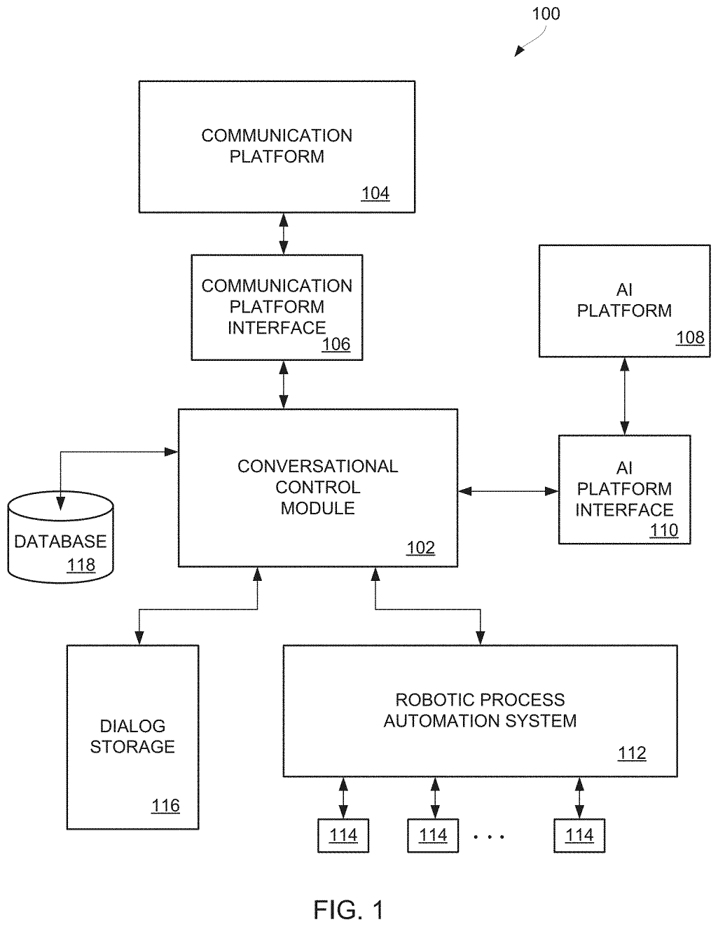

Embodiments of various aspects of the invention are discussed below with reference to FIGS. 1-14. However, those skilled in the art will readily appreciate that the detailed description given herein with respect to these figures is for explanatory purposes as the invention extends beyond these limited embodiments.

FIG. 1 is a conversational robotic process automation (RPA) control system 100 according to one embodiment. The conversational RPA control system 100 includes a conversational control module 102 that controls the operation of the conversational RPA control system 100. The conversational control module 102 can interact with a communication platform 104. In one implementation, the conversational control module 102 interacts with the communication platform 104 by way of a communication platform interface 106. The conversational control module 102 can also interact with an AI platform 108. In one implementation, the conversational control module 102 can interact with the AI platform 108 by way of an AI platform interface 110.

Additionally, the conversational control module 102 can interact with a robotic process automation system 112. The robotic process automation system 112 supports a plurality of different robotic processes, which are denoted software automation processes 114. The software automation processes 114 can also be referred to as “bots.” The robotic process automation system 112 can maintain, execute, and/or monitor software automation processes 114. The robotic process automation system 112 can also report status or results of software automation processes 114.

Further, the conversational control module 102 can interact with a dialog storage 116. The dialog storage 116 can store a plurality of different dialogs. Each different dialog can pertain to a portion of a conversation to be had with a requestor. The requestor is a user that uses the communication platform 104 to request some action from the RPA control system 100. The requestor uses a computing device to interact with the communication platform 104 in a wired or wireless manner. The computing device can, for example, be a mobile phone, tablet computer, desktop computer, and the like. The dialogs serve to elicit responses from the requestor. The dialogs can be text-based or speech-based. In one implementation, the dialogs are associated with a particular one of the software automation processes 114 maintained and operated by the robotic process automation system 112. The dialogs can serve to allow the requestor interacting with the communication platform 104 to effectively interact with the robotic process automation system 112 with the assistance of the conversational control module 102 and related components of the conversational RPA control system 100.

Still further, the conversational control module 102 can interact with a database 118. The database 118 can store structured or relational data for the conversational RPA control system 100. In one embodiment, the database 118 can be used to record conversational data pertaining to one or more active conversations at the communication platform 104 between a requestor and a virtual agent. The recorded conversation data can include requestor data (account, profile, access level, and any other data), conversation state, active dialog, and/or dialog state. For example, in one implementation, the database 118 can provide storage of one or more conversation states, a dialog state, and a user account.

The conversation state can record the state of an on-going structured conversation provide between a user (e.g., requestor) and virtual agent. The dialog state can record the state of an on-going dialog between the virtual agent and a user of the communication platform 104. The user account, is an account for a user and can contain access rights to the robotic process automation system 112.

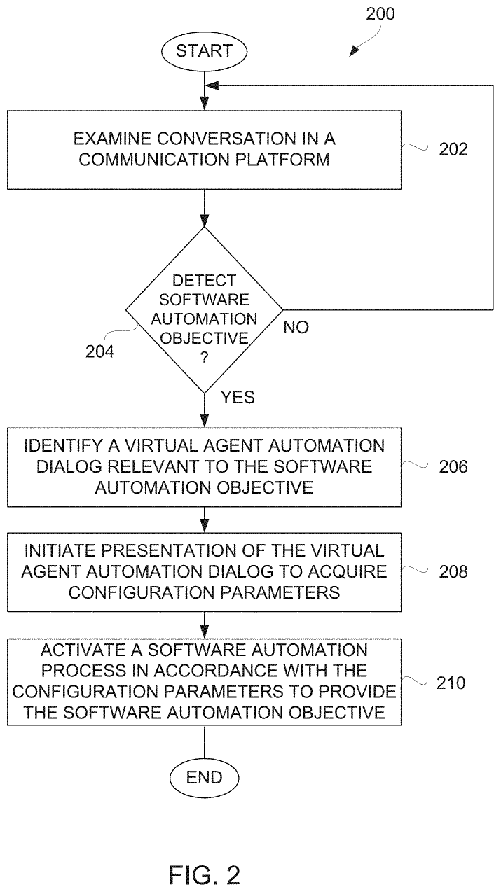

FIG. 2 is a flow diagram of a conversational software automation process 200 according to one embodiment. The conversational software automation process 200 can, for example, be performed by one or more components of the conversational RPA control system 100 illustrated in FIG. 1. Typically, the conversational software automation process 200 is associated with the conversational control module 102 of the conversational RPA control system 100.

The conversational software automation process 200 can initially examine 202 a conversation in a communication platform. The conversation in the communication platform can be ongoing or can be initiated by the user or the virtual agent. A decision 204 can then determine whether a software automation objective has been detected. Here, the conversation is examined 202 to determine whether a software automation objective is being sought by the conversation. When the decision 204 determines that a software automation objective has not been detected, then the conversational software automation process 200 can return to repeat block 202 so that the conversation can be further examined.

On the other hand, when decision 204 determines that the software automation objective has been detected, a virtual agent automation dialog that is relevant to the software automation objective can be identified 206. Next, presentation of the virtual agent automation dialogue can be initiated 208 to acquire configuration parameters. Then, a software automation process can be activated 210 in accordance with the configuration parameters to provide the software automation objective. Here, the software automation process being activated 210 can be identified based on the software automation objective and/or the virtual agent automation dialog. For example, the software automation process being activated 210 can be mapped to the software automation objective and/or the virtual agent automation dialog. Following block 210, the conversational software automation process 200 can end.

Typically, the software automation objective is to provide an interaction with a robotic process automation system, such as the robotic process automation system 112 illustrated in FIG. 1. In the conversational software automation process 200, a software automation process is activated 210 to provide the software automation objective that was detected by examination 202 of the conversation. The software automation process can be one of a plurality of software automation processes available from or provided by the robotic automation system. In other embodiments, the examination 202 of the conversation can cause other interactions with the robotic process automation system. These other interactions need not activate a software automation process.

Instead, the other interactions might request: (i) report(s), (ii) usage information, (iii) performance information, (iv) search of available software automation processes, and/or (v) various other interactions that are supported by the robotic process automation system (e.g., robotic process automation system 112 illustrated in FIG. 1).

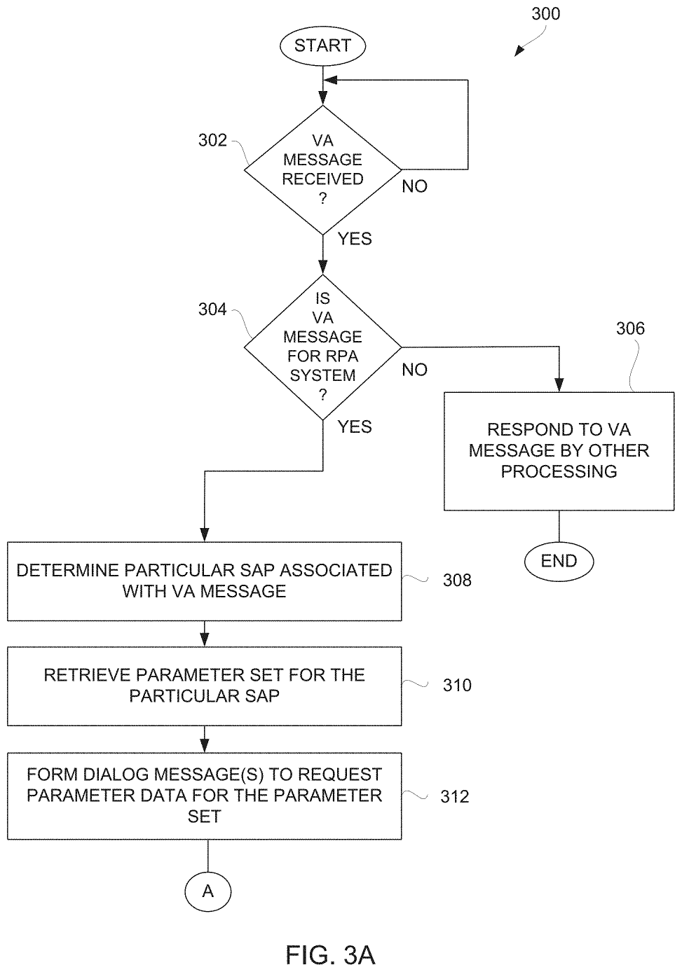

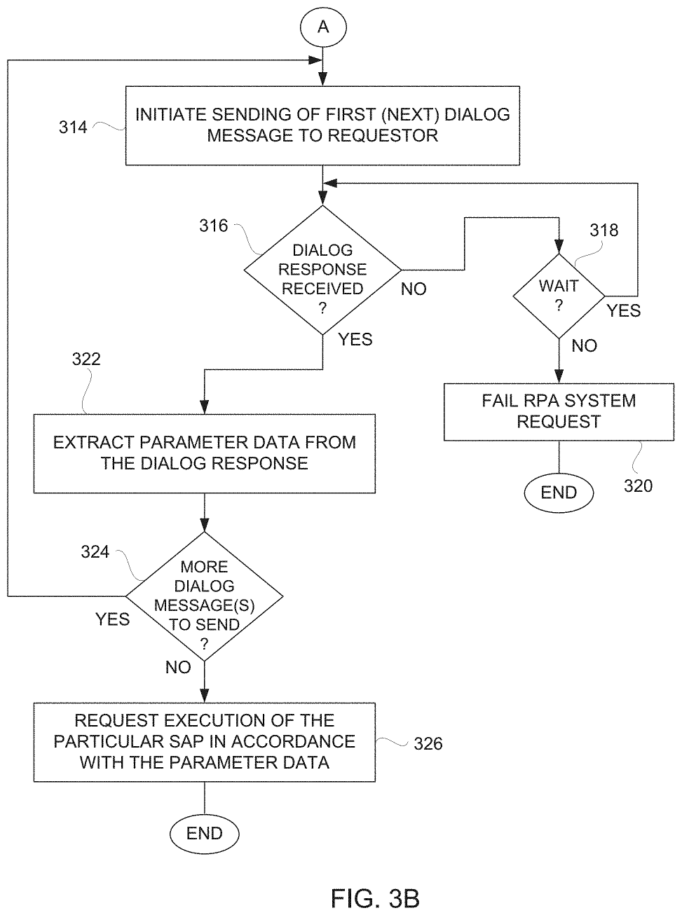

FIGS. 3A and 3B are flow diagrams of a conversational automation process 300 according to one embodiment. The conversational automation process 300 is, for example, performed by a conversational RPA control system, such as the conversational RPA control system 100 illustrated in FIG. 1.

The conversational automation process 300 can begin with a decision 302 that determines whether a virtual assistant (VA) message has been received. The VA message is a message that is received via a communication platform, such as the communication platform 104 illustrated in FIG. 1. Typically, the VA message is from a requestor and is directed to or responding to a virtual assistant that is available to assist the user via the communication platform. The virtual assistant (also referred to as a virtual agent) is a digital assistant or agent that provides user assistance through conversations, such as messaging, using the communication platform. When the decision 302 determines that a VA message has not been received, then the conversational automation process 300 can await receipt of such a message. Alternatively, when the decision 302 determines that a VA message has been received, then a decision 304 can determine whether the VA message is for an RPA system.

When the decision 304 determines that the VA message is not for an RPA system, then the VA message is responded 306 to by other processing. This other processing depends on other system capabilities but is unrelated to the RPA system. Here, the virtual assistant may, but need not, offer assistance with other areas besides an RPA system. Following the block 306, the conversational automation process 300 can end.

On the other hand, when the virtual assistant message is for an RPA system, then a particular software automation process (SAP) associated with the VA message can be determined 308. Here, in one implementation, based on the VA message, the particular software automation process can be determined 308. For example, if the focus of the VA message is to generate and receive a CRM report, the particular software automation process capable of doing so can be identified and utilized. In one embodiment, if there are multiple candidate software automation processes that are capable of doing the focus of the VA message, then additional messaging can be provided via the VA to determine which of the multiple candidate software automation processes is best suited.

After the particular software automation process has been determined 308, a parameter set identifying parameters for the particular software automation process can be retrieved 310. Then, one or more dialog messages can be formed 312 to request parameter data for the parameters in the parameter set. Next, as illustrated in FIG. 3B, the conversational automation process 300 can initiate sending 314 of a dialog message to the requestor. A decision 316 can then determine whether a dialog response has been received. At this time, the dialog response received, if any, would be a dialog response to the dialog message initiated in block 314. When the decision 316 determines that a dialog response is not been received, a decision 318 can determine whether the conversational automation process 300 should await such a response. When the decision 318 determines that the conversational automation process 300 should await such a response, then the processing returns to repeat the decision 316 to await a dialog response to the dialog message that was sent.

Alternatively, when the decision 318 determines that the conversational automation process 300 should no longer await such a response, then the conversational automation process 300 can fail 320 the RPA system request. For example, after a predetermined period of time waiting, the wait for a dialog response can be deemed to have timed-out and thus terminate the dialog and fail (or end) processing of the RPA system request. After the RPA system request has failed 320, the conversational automation process 300 can end.

On the other hand, when the decision 316 determines that a dialog response has been received, then parameter data can be extracted 322 from the dialog response. Thereafter, a decision 324 can determine whether there are any more dialog messages to be sent. When the decision 324 determines that there are one or more dialog messages to be sent, the processing can return to repeat the block 314 and subsequent blocks so that a next dialog message can be sent to the requestor and a response thereto can be processed in a similar fashion. Alternatively, when the decision 324 determines that no more dialog messages are to be sent, execution of the particular software automation process in accordance with the parameter data can be requested 326. Thereafter, the conversational automation process 300 can end.

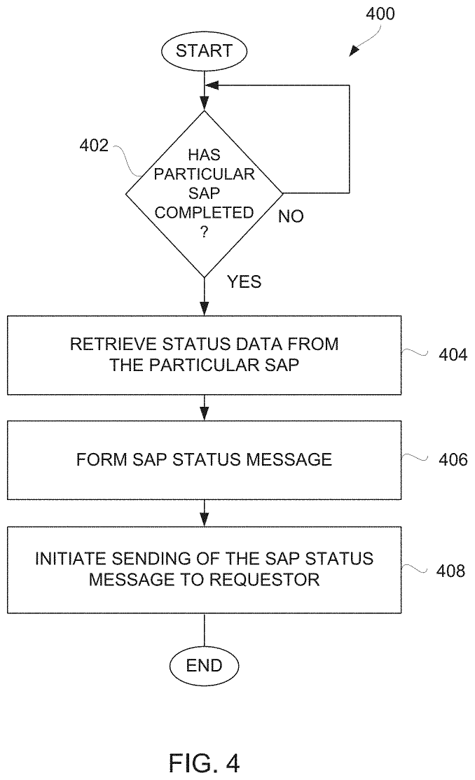

FIG. 4 is a status message process 400 according to one embodiment. The status message process 400 can, for example, follow after the conversational software automation process 300 illustrated in FIGS. 3A and 3B.

The status message process 400 can determine whether a particular software automation process has completed 402. When the decision 402 determines that the particular software automation process has not completed, the status message process 400 can await completion of the particular software automation process. On the other hand, when the decision 402 determines that the particular software automation process has completed, status data from the particular software automation process can be retrieved 404. A status message can then be formed 406. Thereafter, the status message process 400 can initiate sending 408 of the status message to the requestor. The status message can inform the requestor that the particular software automation process has completed its processing and provide further information, such as execution time, time and date of execution, and whether a report was generated. If a report was generated by the particular software automation process, then the status message can also facilitate access to the report. For example, the status message can enable the requestor to download the report or to electronically save the report. The status message can be sent 408 in a variety of ways. In one example, the status message can be sent to the requestor via electronic mail, text message, or other electronic means. In another example, the status message can be sent to the requestor via a virtual agent used with a communication platform, such as the communication platform 104. Following the block 408, the status message process 400 can end.

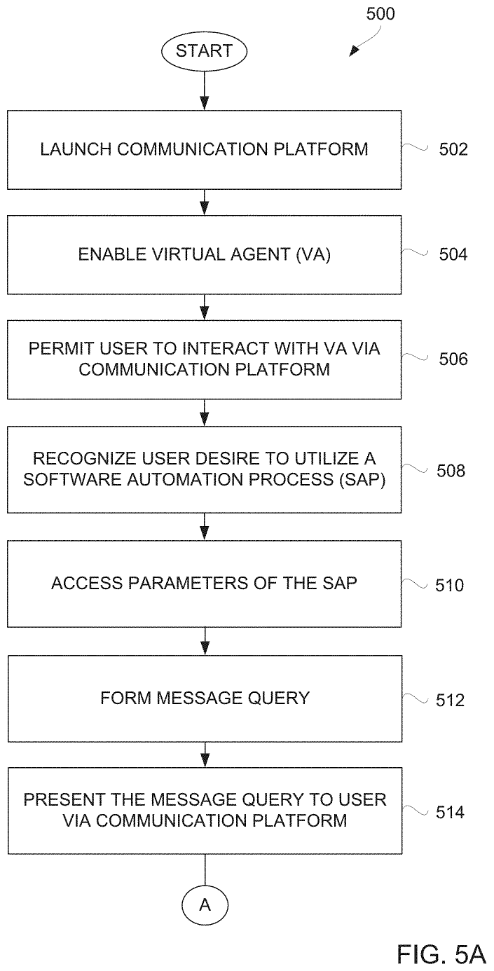

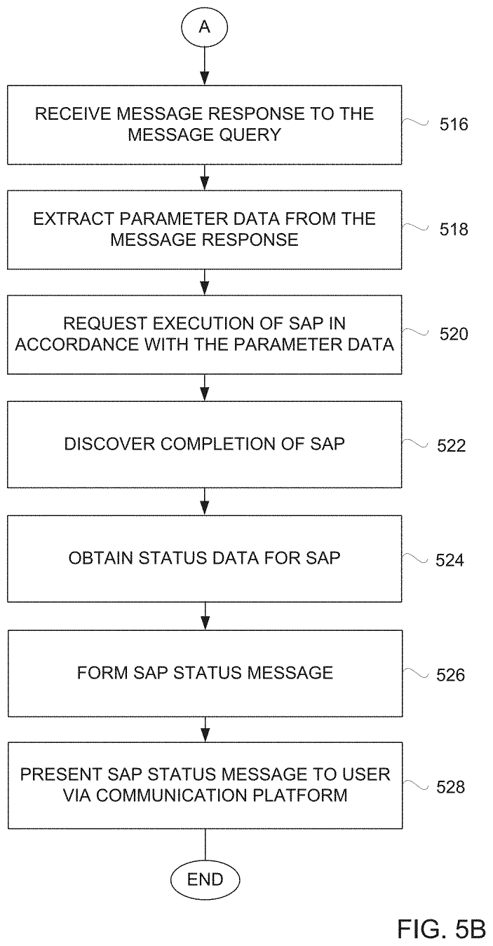

FIGS. 5A and 5B illustrate flow diagrams of a conversational automation process 500 according to one embodiment. The conversational automation process 500 can be performed by a conversational RPA control system, such as the conversational RPA control system 100 illustrated in FIG. 1.

The conversational automation process 500 can launch 502 a communication platform. The communication platform can support one or both of text-based communication and speech-based communication. A virtual agent can also be enabled 504 for use with the communication platform. The virtual agent is a digital agent that provides user assistance through conversations. In this embodiment, the virtual agent is configured to participate in communications or interactions using the communication platform.

Next, a user can be permitted 506 to interact with the virtual agent via the communication platform. The user and the virtual agent can participate in a conversation via the communication platform. In doing so, the conversational automation process 500 can recognize 508 a user's desire to utilize a software automation process (SAP) available from an RPA system. By examining (e.g., parsing) the conversation, the conversational automation process 500 is able to recognize 508 the user's desire to utilize the software automation process. Here, in one implementation, artificial intelligence can be used based on recognizing 508 the user's desire from examination of the conversation between the virtual agent and the user via the communication platform. Since the RPA system supports a plurality of software automation processes, the appropriate software automation process can be identified by the user's desire based on examination of a conversation. However, if there is not clear identification of the appropriate software automation process from the user's desire, then additional dialog can be provided via the communication platform to request and receive additional input from the user using the virtual agent so that the appropriate software automation process can be properly identified.

After the user's desire to utilize the software automation process has been recognized 508, parameters of the software automation process can be accessed 510. Here, each software automation process typically requires one or more input parameters (or variables) for its proper execution. Thus, a message query can be formed 512. The message query can, for example, request parameter input from the user. After the message query has been formed 512, the message query can be presented 514 to the user via the communication platform, such as via the virtual agent. Here, each software automation process typically requires one or more input parameters (or variables) for its proper execution. The message query that is formed 512 and presented 514 can seek the one or more input parameters from the user in a conversational fashion via the communication platform.

Referring now to FIG. 5B, following the message query being presented 514, a message response to the message query can be received 516. Parameter data can then be extracted 518 from the message response. There can, in one embodiment, be one or more message queries and message responses to gather the parameter data for the one or more input parameters. The parameter data that is extracted 518 can undergo one or more validation checks. If the parameter data fails the validation checks, the corresponding parameter data can be rejected and a revised message query can be presented to solicit valid parameter data from the user. As an example, the validation checks can check the parameter data for proper variable type (e.g., string, number, etc.), size and/or range. If the parameter data falls out of a range, for example, then a revised message query can be presented for the user to again input the parameter data.

Next, execution of the software automation process and can be requested 520 in accordance with the parameter data. After the software automation process has started its execution, the software automation process will eventually complete its tasks. The completion of the software automation process can be discovered 522. After the completion of the software automation process has been discovered 522, status data for the software automation process can be obtained 524. For example, the conversational automation process 500 can request and receive the status data from the software automation process itself or its robotic process automation system, such as the robotic process automation system 112 shown in FIG. 1. Then, a software automation process status message can be formed 526 based on the status data. Finally, the status message can be presented 528 to the user via the communication platform. Alternatively, the status message can be electronically transmitted or presented 528 to the user without using the communication platform.

Software automation processes can be used in a wide range of computing environments or situations. One example of a particular software automation process provides interaction with a CRM software system. Typically, CRM software systems are used to provide various reports, such as sales report.

The conversational control module, such as the conversational control module 102, can decipher a requestor's desire from a conversation happening in a communication platform. The conversational control module can be assisted by an AI platform, such as the AI platform 108. In such case, the AI platform can serve to decipher the requestor's desire from the conversation in the communication platform. In this example, the requestor desires to get a CRM report. The AI platform can, for this example, retrieving reports for CRM reports (e.g., Salesforce reports) can be trained to understand this specific desire of the requestor. For instance, the AI platform can be trained to recognize such a specific desire by being provided some examples of what the user might say:

1. Get my Salesforce report

2. Retrieve my sales report

3. Download my Salesforce report for me?

4. Can you get my sales report?

These examples are fed into the AI platform, which will create a machine learning module that will understand new speech that are not in the examples. In this case, the desire (or intent) can be specifically mapped to the “Get Report” intent which have been defined. One suitable AI platform is LUIS available from Microsoft Corporation at www.luis.ai. LUIS is a machine learning-based service designed to identify valuable information in conversations. LUIS can interpret user goals (intents) and distills valuable information from sentences (entities), for a high quality, nuanced language model.

In one embodiment, the AI platform can extract the “subject” entity. In LUIS, entities are any pieces of information that can be extracted from speech. In this embodiment, the “subject” entity is being extracted by the AI platform, which in our example, is input “Salesforce report.” The “subject” entity is useful because the user might also seek other reports from other systems, for example, Facebook, Google, Oracle, etc. By extracting “subject,” the conversational control module can then determine which specific report to receive or obtain.

The following examples are simply for illustration purposes only and not intended to be limiting in any way.

As an example, an exemplary response to an Application Programming Interface (API) call to the AI platform to evaluate a communication (e.g., query) received via the communication platform 104 can be as follows.

{

“query”: “ Download my Salesforce report for me?”,
“prediction”: {

“normalizedQuery”: “download my salesforce report for me”,
“top_Intent”: “Get Report”,
“intents”: {

“ Get Report ”: {

“score”: 0.984749258

}

}

},
“entities”: {

“subject”: [

“Salesforce report”

],

}

}

In this example API call, the query is what the requestor (or user) entered via the communication platform. The conversational control module can examine the response from the AI platform and extract (i) intent, which is “Get Report”, and (ii) subject, which is “Salesforce report”. The “top_intent” is the intent used as the requestor's desire, and the entities contain the subject of the conversation (e.g., query).

Hence, an exemplary software automation process of a CRM software system might then be used to generate a sales report, as being understood as the requestor's desire. However, typically, the exemplary software automation process requires one or more parameters (or variables), namely input parameters (or variables). For example, the parameters for the exemplary software automation process might include: Region, Date and Report. The Region can be a character string identifying a geographic region for the report. The Date can be a character string identifying a date or date range for the report. The Report can be a number identifying a type or format for the report.

In one embodiment, the robotic process automation system supporting the exemplary software automation process, can be accessed to request and receive the parameters that are needed for the exemplary software automation process. In one implementation, the robotic process automation system can include an API that programmatically permits access to the parameter information for the various software automation processes it supports. For example, for the exemplary software automation process that provides a sales report from a CRM system, an API can be used to request and receive a set of parameters (or variables). The set of parameters (or variables) for the exemplary software automation process provided via the API, might be denoted as:

“variables”: [

{

“name”: “Region”,
“description”: “”,
“type”: “STRING”,
“readOnly”: false,
“input”: true,
“output”: false,
“defaultValue”: {

“type”: “STRING”,
“string”: “”

}

},
{

“name”: “Date”,
“description”: “”,
“type”: “DATETIME”,
“readOnly”: false,
“input”: true,
“output”: false,
“defaultValue”: {

“type”: “DATETIME”,
“string”: “2020-01-01T00:00:00-08:00[US/Pacific]”

}

},
{

“name”: “Report”,
“description”: “”,
“type”: “NUMBER”,
“readOnly”: false,
“input”: true,
“output”: false,
“defaultValue”: {

“type”: “NUMBER”,
“number”: “0”

}

}

],

Hence, in this example, the set of parameters (or variables) for the exemplary software automation process to provide a sales report for the CRM system includes: Region, Date and Report, which are input parameters (or variables).

Thereafter, when the conversational control module is ready to execute the exemplary software automation process using the robotic process automation system, such as the robotic process automation system 112, the conversational control module can issue an API call to the robotic process automation system requesting execution of the exemplary software automation process and provide any needed parameters (or variables) therefor. An exemplary API call to the robotic process automation system for a sale report from the CRM system may be as follows.

{

“fileId”:48,
“runAsUserIds”:[

“5”

],
“poolIds”:[
],
“overrideDefaultDevice”:false,
“botInput”:{

“Report”:{

“type”:“NUMBER”,
“number”:“1”

},
“ Region ”:{

“type”:“STRING”,
“string”:“North America”

},
“Region”:{

“type”:“BOOLEAN”,
“string”:“true”

},
“Date”:{

“type”:“DATETIME”,
“string”:“1/1/2020”

}

}

}

When the exemplary software automation process completes its execution, the desired sales report may be produced. Hence, at this point the requestor can be alerted to the availability of the sales report. More particularly, on completion, the exemplary software automation process returns a result back to the conversational control module that can be used to cause a message to be provided back to the requestor via the communication platform 104. An example of a result callback from the exemplary software automation process after it has completed execution can be as follows.

{

“userId”: 1,
“deploymentId”: 1,
“status”: “RUN_COMPLETE”,
“botOutput”: {

“ReportName”:{

“Type”: “STRING”,
“STRING”: “Daily Report”

},
“FileDownloadURL”:{

“Type”: “STRING”,
“STRING”: “http://1.1.1.1/dailyreport.exc”

}

}

}

In this example, the exemplary software automation process on completion returns two output variables, “ReportName” and “FileDownloadURL”. These variables can be extracted from the returned data at the conversational control module. The conversational control module can then interact with the communication platform 104 to cause the virtual agent to return result information to the requestor. In this example, the communication provided to the requestor can be information that the requested report, denoted “Daily Report”, is ready and available for download from at a denoted Universal Resource Locator (URL).

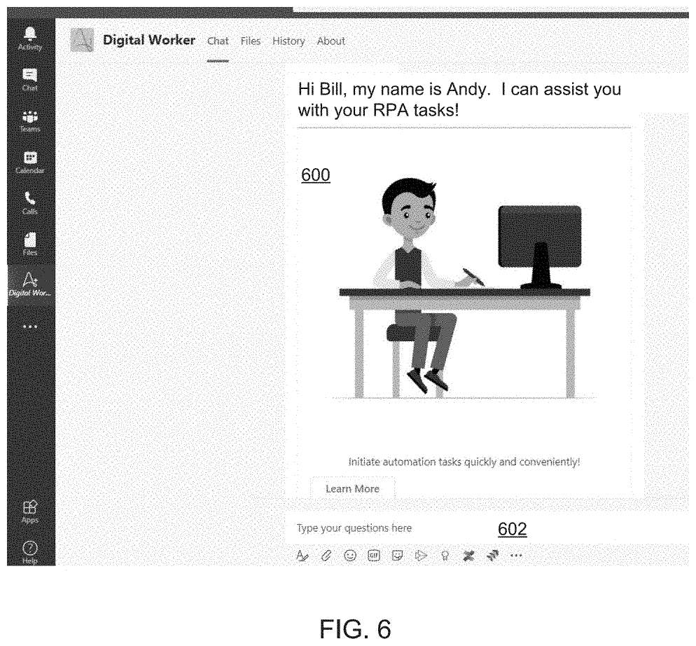

As noted previously, the conversational-based user interface allows a requestor (or user) to interface with a robotic process automation system in a conversational fashion. In such cases, the communication provided in the conversational fashion may not occur in real-time but can be extended over a period of time, such as several minutes, hours or days. Typically, such communication may also be unstructured. The conversational-based user interface can cause a virtual agent to present graphical user interface screens to the requestor (or user). Exemplary graphical user interface screens are described below with reference to FIGS. 6-9.

FIG. 6 is a screen depiction of an exemplary graphical user interface 600 providing a virtual agent operating in a communication platform, according to one embodiment. In this example, the virtual agent is referred to as Andy. The virtual agent is operating in the communication platform. For example, one suitable communication platform can be “Teams,” which is a unified communication and collaboration platform from Microsoft Corporation of Seattle, Wash. The graphical user interface 600 can provide a text box 602 where a user can enter (e.g., type) a question or request (or query) for a robotic process automation system. Such question or request can be fielded by the virtual agent. As previously noted, the question or request can be examined to determine the user's desire, such as in block 202 of FIG. 2, block 304 in FIG. 3A or block 508 in FIG. 5A.

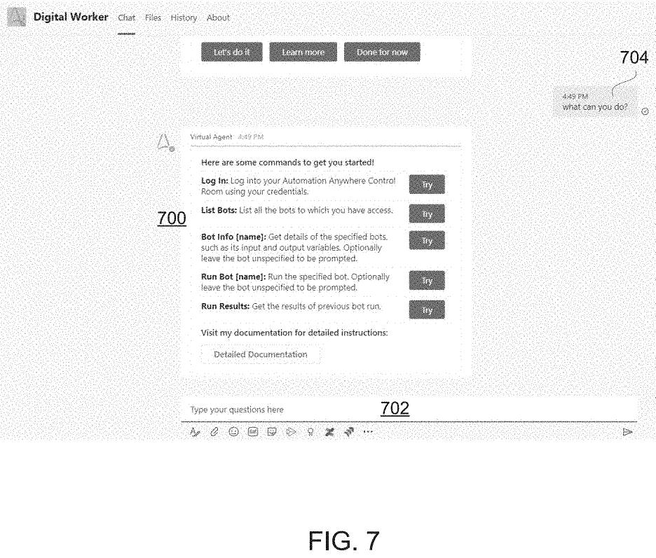

FIG. 7 is a screen depiction of an exemplary graphical user interface 700 indicating some capabilities of a virtual agent operating in a communication platform, according to one embodiment. The graphical user interface 700 can be presented in response to a question, “what can you do?” (704), previously entered in the text box 602 shown in FIG. 6. In response thereto, the graphical user interface 700 can present a response to the question. In this example, the response indicates various commands that can be initiated using the virtual agent. The graphical user interface 700 can also provide a text box 702 where a user can enter (e.g., type) another question or request to be fielded by the virtual agent. In one embodiment, the virtual agent is particularly adept at assisting the user in interacting with a robotic process automation system, such as the robotic process automation system 112 shown in FIG. 1. Hence, in this exemplary graphical user interface 700, the virtual agent supports various commands concerning the robotic process automation system, including: Log In, List Bots, Bot Information, Run Bot, and Run Results. The Log In command can facilitate login to the robotic process automation system using one's login credentials. The List Bots command can request a list of all software automation processes (e.g., bots) that are available to the user. The Bot Information [name] command can request details, such as input and output variables, for a specified software automation process (e.g., bot). The Run Bot [name] command can be used to run a specified software automation process (e.g., bot). The Run Results command can get results from previously run software automation processes (e.g., bots). On selection of an available command, an associated dialog can be initiated. For example, the dialog storage 116 can store distinct dialogs to be used by the virtual agent operating via the communication platform. For these exemplary commands, on requesting one of the commands, an associated dialog can be retrieved from the dialog storage 116 and initiated by the conversational control module 102 so the associated dialog can be carried out between the virtual agent and the user via the communication platform 104. Besides the dialogs for such exemplary commands, there can be other dialogs such as a help dialog, a greeting dialog, etc.

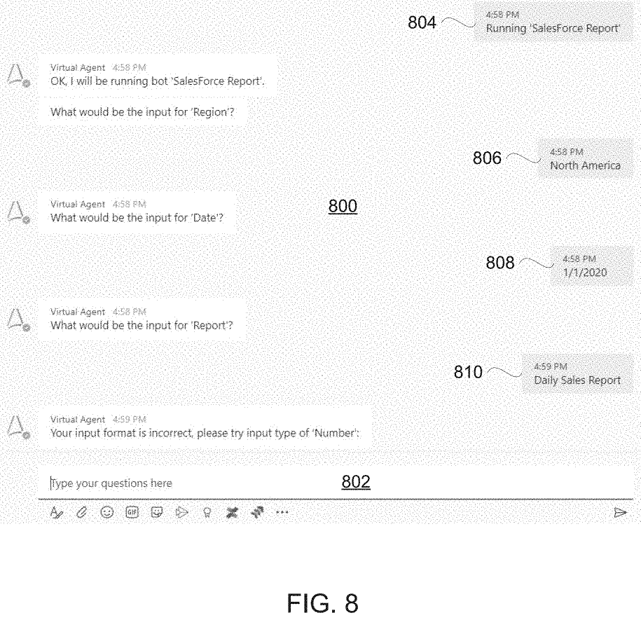

FIG. 8 is a screen depiction of an exemplary graphical user interface 800 indicating a prior request and a series of conversational requests and responses, according to one embodiment. The prior request was entered in a text box, such as the text box 602 shown in FIG. 6 or the text box 702 shown in FIG. 7. The prior request, in this example, indicates that the user is interested in “Running ‘SalesForce Report’,” which is a CRM report. The RPA control system, such as the RPA control system 100, determines an appropriate software automation process (e.g., bot) that is capable of producing the sales report being requested. The graphical user interface 800 also shows additional conversation having an interactive dialog between the user and the virtual agent to acquire parameters (or variables) that are need to run the appropriate software automation process (e.g., bot) that will produce the CRM report being requested. The interactive dialog for the parameters serves to request (by the virtual agent) and receive (from the user) three input parameters for the appropriate software automation process. In this example, the two of three input parameters are were acquired, namely, Region=North America (806), and Date=1/1/2020 (808). The third input parameter for Report was initially provided as Daily Sales Report (810), but that input was not accepted as it was not of a proper variable type. Hence, the virtual agent requests 812 the user to again provide the third input parameter and advises the user that the correct variable type for the input is a number. The graphical user interface 800 can also provide a text box 802 where a user can enter (e.g., type) in the responses for the requested input parameters.

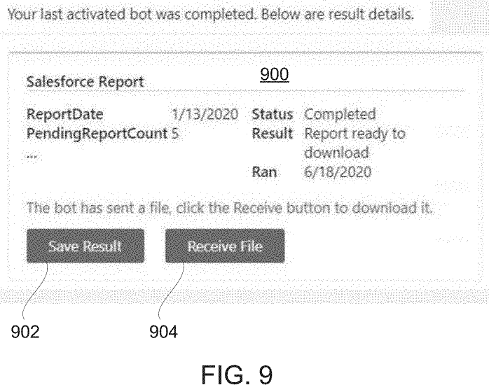

FIG. 9 is a screen depiction of an exemplary graphical user interface 900 indicating status data concerning performance of a software automation process, according to one embodiment. In one embodiment, the status data for the execution of the exemplary software automation process can be provided to the user by the exemplary graphical user interface 900. The exemplary graphical user interface 900 can include status information (e.g., date ran, completed, results) and can inform the user that a report has been generated and is available for access. The exemplary graphical user interface 900 can include a user-selectable control 902 to cause the report to be saved for the user, and a user-selectable control 904 to receive an electronic file of the report.

Dialogs can also be customized to users or enterprises. Dialogs can be different depending on the conversation type, such as text, natural language, or form-based. Inputs sought and/or input default values for dialogs can also be customized. Validation to be performed can be customized. Dialogs can make use of pre-defined questions. Dialogs can also be dependent on status of a relevant software automation process (e.g., bot), such as active or disabled. The customization can be on all conversations of a user or enterprise, or can differ for each conversation of a user or enterprise.

As noted above a database, such as the database 118 illustrated in FIG. 1, can provide storage of various management data, including data for facilitating use of dialogs. The data being stored can, for example, include identifiers, states, and user data. Although the database structure and/or data being stored in the database can vary widely with implementation, an exemplary structure for storage of management data is as follows.

{

“id”: “emulator*2fconversations*2f45d81880-8325-11ea-84df-

2713f33aa08e | livechat”,

“realId”: “emulator/conversations/45d81880-8325-11ea-84df-

2713f33aa08e | livechat”,

“document”: {

“$type”: “System.Collections.Generic. Dictionary′2[[System.String,

System.Private.Core Lib],[System.Object, System.Private.CoreLib]],
System.Private.CoreLib”,

“DialogState”: {

“$type”: “Microsoft.Bot.Builder.Dialogs.DialogState,

Microsoft.Bot.Builder.Dialogs”,

“dialogStack”: {

“$type”: “System.Collections.Generic.List′1[[Microsoft.Bot.Build

er.Dialogs.DialogInstance, Microsoft.Bot.Builder.Dialogs]],
System.Private.CoreLib”,

“$values”: [ ]

}

},
“DialogStateDictionary”: {

“$type”: “VirtualAgent.Models.DialogStateDictionary,

VirtualAgent”,

“SearchBotDialog”: null,
“SearchBotSubflow”: null

},
“UserStateModel”: {

“$type”: “VirtualAgent.Models.UserStateModel, VirtualAgent”,
“AuthContext”: {

“$type”: “AAI.Shared.AuthorizationContext, AAI.Shared”,
“Url”: “http://40.113.230.2”,
“Token”: “eyJhbGciOiJSUzUxMiJ9.eyJzdWIiOiI0IiwiY2xpZW50VHl

wZSI6IldFQiIsImxpY2Vuc2VzIjpbIlJVTlRJTUUiXSwiYW5hbHl0aWNzTGIjZW5
zZXNQdXJjaGFzZWQiOnsiQW5hbHl0aWNzQ2xpZW50Ijp0cnVlLCJBbmFse
XRpY3NBUEkiOnRydWV9LCJ0ZW5hbnRVdWlkIjoiMDAwMDAwMDAtMDA
wMC0wMDAwLTAwMDAtMDAwMDAwMDAwMDAwIiwiaHlicmlkVGVuY
W50IjoiIiwiaWF0IjoxNTg3NDAxMDUxLCJleHAiOjE1ODc0MDIyNTEsImlzcyI
6IkF1dG9tYXRpb25Bbnl3aGVyZSIsIm5hbm9UaW1lIjo0MDkyODI5MjA5Mj
c5MDB9.Z5SDqyJHOhld1tZWvxwMA10Ctwzd7jrAaCmWFLtcY12Vi2dijkj9k
3_phlMAUnWQ4YkCK6W-11EQXbJHccxUj_wVdC8qkAcrDsG-
xINp45Mri4aQYdQqm5CARicHjlNdPoJCA2E9d2g4FQ8_ywD7rm3ujHpI_{——}D
7X2G9atgrnHWQFng8s9nzytR88QyvDzjYvlrEacG4s2RQ62ZlZkcn7F9V2B_p
P_6XZidernaef-tWQnRWeRXyDgATBVjHheU6aOvfVuWoZ0A1ZDuRD_{—}
gnZw0nyxMYm8gl7k7EZAzfGX5ZaG0ENIQ07WyW7MhI6k21VOT9ACJ7Gb
9QSYGd7iq2Mg”,

“Username”: “runner-account”

},
“ClientId”: “c4871a36-c74e-4ac9-88f2-de88f2825c47”,
“Name”: “User”,
“TenantId”: null,
“Channel”: 2,
“RunHistories”: {

“$type”: “System.Collections.Generic.LinkedList′1[[VirtualAgent.

Models.RunHistory, VirtualAgent]], System.Collections”,

“$values”: [ ]

}

}

},
“_etag”: “\”020085d9-0000-0800-0000-5e9dd15c0000\“”,
“PartitionKey”: “emulator*2fconversations*2f45d81880-8325-11ea-

84df-2713f33aa08e | livechat”,

“_rid”: “WconAJaDRuMLAAAAAAAAAA==”,
“_self”: “dbs/WconAA==/colls/WconAJaDRuM=/docs/WconAJaDRuML

AAAAAAAAAA==/”,

“_attachments”: “attachments/”,
“_ts”: 1587401052

}

In this exemplary structure, various variables are stored to assist with management of dialogs. In this example, the dialog management data can store identifiers, documents, states, and user data. For example, the variable “DialogState” can be used to record and thus track where in a given dialog the communication interchange is with a particular user. A variable “dialogStack” can be used to record a stack position (or level) within a dialog. As another example, the variable “DialogStateDictionary” can be used to record dialog variables that have be acquired. As still another example, the “UserStateModel” can be used to record and thus track information about the user. The information about the user recorded in the “UserStateModel” can, for example, include “AuthContext” (with URL, token and Username) to track user login to a RPA system; “ClientId” to track the particular user in the conversation; “TenantId” to track a particular company to which the particular user is affiliated; and “RunHistories” to track a history of all software automation processes (e.g., bots) the particular user has previously run.

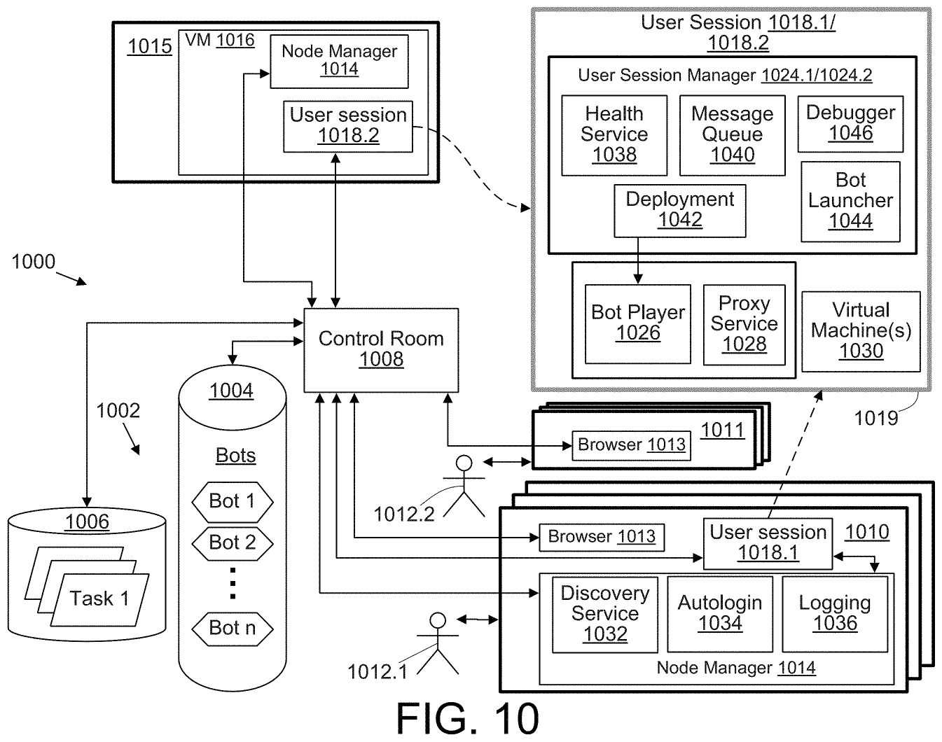

FIG. 10 is a block diagram of a robotic process automation (RPA) system 1000 according to one embodiment. The RPA system 1000 includes data storage 1002. The data storage 1002 can store a plurality of software robots 1004, also referred to as bots (e.g., Bot 1, Bot 2, . . . , Bot n). The software robots 1004 can be operable to interact at a user level with one or more user level application programs (not shown). As used herein, the term “bot” is generally synonymous with the term software robot. In certain contexts, as will be apparent to those skilled in the art in view of the present disclosure, the term “bot runner” refers to a device (virtual or physical), having the necessary software capability (such as bot player 1026), on which a bot will execute or is executing. The data storage 1002 can also stores a plurality of work items 1006. Each work item 1006 can pertain to processing executed by one or more of the software robots 1004.

The RPA system 1000 can also include a control room 1008. The control room 1008 is operatively coupled to the data storage 1002 and is configured to execute instructions that, when executed, cause the RPA system 1000 to respond to a request from a client device 1010 that is issued by a user 1012.1. The control room 1008 can act as a server to provide to the client device 1010 the capability to perform an automation task to process a work item from the plurality of work items 1006. The RPA system 1000 is able to support multiple client devices 1010 concurrently, each of which will have one or more corresponding user session(s) 1018, which provides a context. The context can, for example, include security, permissions, audit trails, etc. to define the permissions and roles for bots operating under the user session 1018. For example, a bot executing under a user session, cannot access any files or use any applications that the user, under whose credentials the bot is operating, does not have permission to do so. This prevents any inadvertent or malicious acts from a bot under which bot 1004 executes.

The control room 1008 can provide, to the client device 1010, software code to implement a node manager 1014. The node manager 1014 executes on the client device 1010 and provides a user 1012 a visual interface via browser 1013 to view progress of and to control execution of automation tasks. It should be noted that the node manager 1014 can be provided to the client device 1010 on demand, when required by the client device 1010, to execute a desired automation task. In one embodiment, the node manager 1014 may remain on the client device 1010 after completion of the requested automation task to avoid the need to download it again. In another embodiment, the node manager 1014 may be deleted from the client device 1010 after completion of the requested automation task. The node manager 1014 can also maintain a connection to the control room 1008 to inform the control room 1008 that device 1010 is available for service by the control room 1008, irrespective of whether a live user session 1018 exists. When executing a bot 1004, the node manager 1014 can impersonate the user 1012 by employing credentials associated with the user 1012.

The control room 1008 initiates, on the client device 1010, a user session 1018 (seen as a specific instantiation 1018.1) to perform the automation task. The control room 1008 retrieves the set of task processing instructions 1004 that correspond to the work item 1006. The task processing instructions 1004 that correspond to the work item 1006 can execute under control of the user session 1018.1, on the client device 1010. The node manager 1014 can provide update data indicative of status of processing of the work item to the control room 1008. The control room 1008 can terminate the user session 1018.1 upon completion of processing of the work item 1006. The user session 1018.1 is shown in further detail at 1019, where an instance 1024.1 of user session manager 1024 is seen along with a bot player 1026, proxy service 1028, and one or more virtual machine(s) 1030, such as a virtual machine that runs Java® or Python®. The user session manager 1024 provides a generic user session context within which a bot 1004 executes.

The bots 1004 execute on a player, via a computing device, to perform the functions encoded by the bot. Some or all of the bots 1004 may in certain embodiments be located remotely from the control room 1008. Moreover, the devices 1010 and 1011, which may be conventional computing devices, such as for example, personal computers, server computers, laptops, tablets and other portable computing devices, may also be located remotely from the control room 1008. The devices 1010 and 1011 may also take the form of virtual computing devices. The bots 1004 and the work items 1006 are shown in separate containers for purposes of illustration but they may be stored in separate or the same device(s), or across multiple devices. The control room 1008 can perform user management functions, source control of the bots 1004, along with providing a dashboard that provides analytics and results of the bots 1004, performs license management of software required by the bots 1004 and manages overall execution and management of scripts, clients, roles, credentials, security, etc. The major functions performed by the control room 1008 can include: (i) a dashboard that provides a summary of registered/active users, tasks status, repository details, number of clients connected, number of scripts passed or failed recently, tasks that are scheduled to be executed and those that are in progress; (ii) user/role management—permits creation of different roles, such as bot creator, bot runner, admin, and custom roles, and activation, deactivation and modification of roles; (iii) repository management—to manage all scripts, tasks, workflows and reports etc.; (iv) operations management—permits checking status of tasks in progress and history of all tasks, and permits the administrator to stop/start execution of bots currently executing; (v) audit trail—logs creation of all actions performed in the control room; (vi) task scheduler—permits scheduling tasks which need to be executed on different clients at any particular time; (vii) credential management—permits password management; and (viii) security: management—permits rights management for all user roles. The control room 1008 is shown generally for simplicity of explanation. Multiple instances of the control room 1008 may be employed where large numbers of bots are deployed to provide for scalability of the RPA system 1000.

In the event that a device, such as device 1011 (e.g., operated by user 1012.2) does not satisfy the minimum processing capability to run a node manager 1014, the control room 1008 can make use of another device, such as device 1015, that has the requisite capability. In such case, a node manager 1014 within a Virtual Machine (VM), seen as VM 1016, can be resident on the device 1015. The node manager 1014 operating on the device 1015 can communicate with browser 1013 on device 1011. This approach permits RPA system 1000 to operate with devices that may have lower processing capability, such as older laptops, desktops, and portable/mobile devices such as tablets and mobile phones. In certain embodiments the browser 1013 may take the form of a mobile application stored on the device 1011. The control room 1008 can establish a user session 1018.2 for the user 1012.2 while interacting with the control room 1008 and the corresponding user session 1018.2 operates as described above for user session 1018.1 with user session manager 1024 operating on device 1010 as discussed above.

In certain embodiments, the user session manager 1024 provides five functions. First is a health service 1038 that maintains and provides a detailed logging of bot execution including monitoring memory and CPU usage by the bot and other parameters such as number of file handles employed. The bots 1004 can employ the health service 1038 as a resource to pass logging information to the control room 1008. Execution of the bot is separately monitored by the user session manager 1024 to track memory, CPU, and other system information. The second function provided by the user session manager 1024 is a message queue 1040 for exchange of data between bots executed within the same user session 1018. The third function is a deployment service (also referred to as a deployment module) 1042 that connects to the control room 1008 to request execution of a requested bot 1004. The deployment service 1042 can also ensure that the environment is ready for bot execution, such as by making available dependent libraries. The fourth function is a bot launcher 1044 which can read metadata associated with a requested bot 1004 and launch an appropriate container and begin execution of the requested bot. The fifth function is a debugger service 1046 that can be used to debug bot code.

The bot player 1026 can execute, or play back, a sequence of instructions encoded in a bot. The sequence of instructions can, for example, be captured by way of a recorder when a human performs those actions, or alternatively the instructions are explicitly coded into the bot. These instructions enable the bot player 1026, to perform the same actions as a human would do in their absence. In one implementation, the instructions can compose of a command (action) followed by set of parameters, for example: Open Browser is a command, and a URL would be the parameter for it to launch a web resource. Proxy service 1028 can enable integration of external software or applications with the bot to provide specialized services. For example, an externally hosted artificial intelligence system could enable the bot to understand the meaning of a “sentence.”

The user 1012.1 can interact with node manager 1014 via a conventional browser 1013 which employs the node manager 1014 to communicate with the control room 1008. When the user 1012.1 logs in from the client device 1010 to the control room 1008 for the first time, the user 1012.1 can be prompted to download and install the node manager 1014 on the device 1010, if one is not already present. The node manager 1014 can establish a web socket connection to the user session manager 1024, deployed by the control room 1008 that lets the user 1012.1 subsequently create, edit, and deploy the bots 1004.

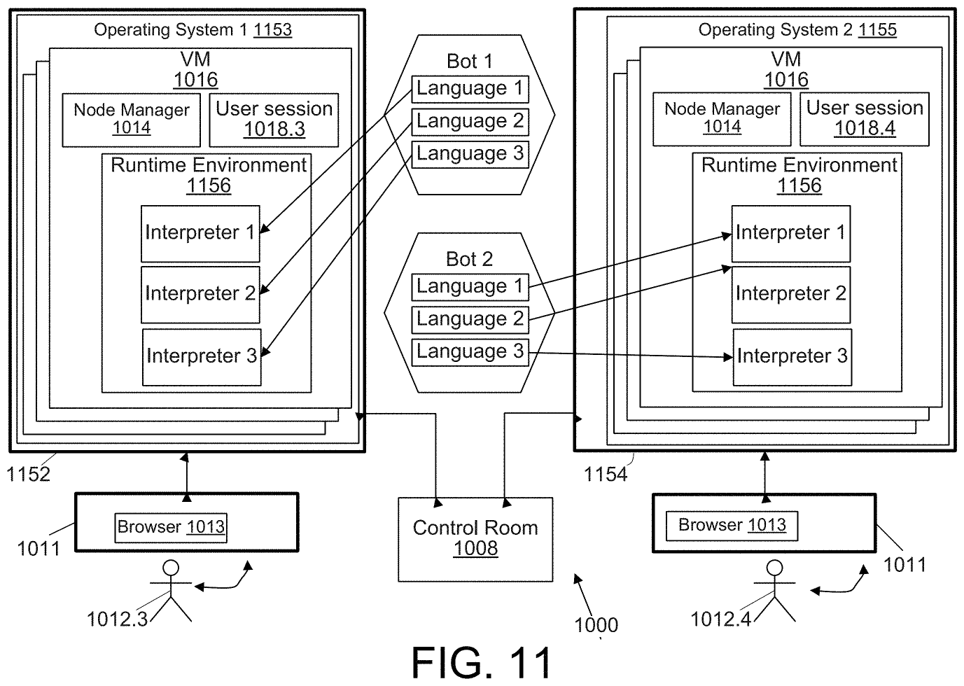

FIG. 11 is a block diagram of a generalized runtime environment for bots 1004 in accordance with another embodiment of the RPA system 1000 illustrated in FIG. 10. This flexible runtime environment advantageously permits extensibility of the platform to enable use of various languages in encoding bots. In the embodiment of FIG. 11, RPA system 1000 generally operates in the manner described in connection with FIG. 10, except that in the embodiment of FIG. 11, some or all of the user sessions 1018 execute within a virtual machine 1016. This permits the bots 1004 to operate on an RPA system 1000 that runs on an operating system different from an operating system on which a bot 1004 may have been developed. For example, if a bot 1004 is developed on the Windows® operating system, the platform agnostic embodiment shown in FIG. 11 permits the bot 1004 to be executed on a device 1152 or 1154 executing an operating system 1153 or 1155 different than Windows®, such as, for example, Linux. In one embodiment, the VM 1016 takes the form of a Java Virtual Machine (JVM) as provided by Oracle Corporation. As will be understood by those skilled in the art in view of the present disclosure, a JVM enables a computer to run Java® programs as well as programs written in other languages that are also compiled to Java® bytecode.

In the embodiment shown in FIG. 11, multiple devices 1152 can execute operating system 1, 1153, which may, for example, be a Windows® operating system. Multiple devices 1154 can execute operating system 2, 1155, which may. for example, be a Linux® operating system. For simplicity of explanation, two different operating systems are shown, by way of example and additional operating systems such as the macOS®, or other operating systems may also be employed on devices 1152, 1154 or other devices. Each device 1152, 1154 has installed therein one or more VM's 1016, each of which can execute its own operating system (not shown), which may be the same or different than the host operating system 1153/1155. Each VM 1016 has installed, either in advance, or on demand from control room 1008, a node manager 1014. The embodiment illustrated in FIG. 11 differs from the embodiment shown in FIG. 10 in that the devices 1152 and 1154 have installed thereon one or more VMs 1016 as described above, with each VM 1016 having an operating system installed that may or may not be compatible with an operating system required by an automation task. Moreover, each VM has installed thereon a runtime environment 1156, each of which has installed thereon one or more interpreters (shown as interpreter 1, interpreter 2, interpreter 3). Three interpreters are shown by way of example but any run time environment 1156 may, at any given time, have installed thereupon less than or more than three different interpreters. Each interpreter 1156 is specifically encoded to interpret instructions encoded in a particular programming language. For example, interpreter 1 may be encoded to interpret software programs encoded in the Java® programming language, seen in FIG. 11 as language 1 in Bot 1 and Bot 2. Interpreter 2 may be encoded to interpret software programs encoded in the Python® programming language, seen in FIG. 11 as language 2 in Bot 1 and Bot 2, and interpreter 3 may be encoded to interpret software programs encoded in the R programming language, seen in FIG. 11 as language 3 in Bot 1 and Bot 2.

Turning to the bots Bot 1 and Bot 2, each bot may contain instructions encoded in one or more programming languages. In the example shown in FIG. 11, each bot can contain instructions in three different programming languages, for example, Java®, Python® and R. This is for purposes of explanation and the embodiment of FIG. 11 may be able to create and execute bots encoded in more or less than three programming languages. The VMs 1016 and the runtime environments 1156 permit execution of bots encoded in multiple languages, thereby permitting greater flexibility in encoding bots. Moreover, the VMs 1016 permit greater flexibility in bot execution. For example, a bot that is encoded with commands that are specific to an operating system, for example, open a file, or that requires an application that runs on a particular operating system, for example, Excel® on Windows®, can be deployed with much greater flexibility. In such a situation, the control room 1008 will select a device with a VM 1016 that has the Windows® operating system and the Excel® application installed thereon. Licensing fees can also be reduced by serially using a particular device with the required licensed operating system and application(s), instead of having multiple devices with such an operating system and applications, which may be unused for large periods of time.

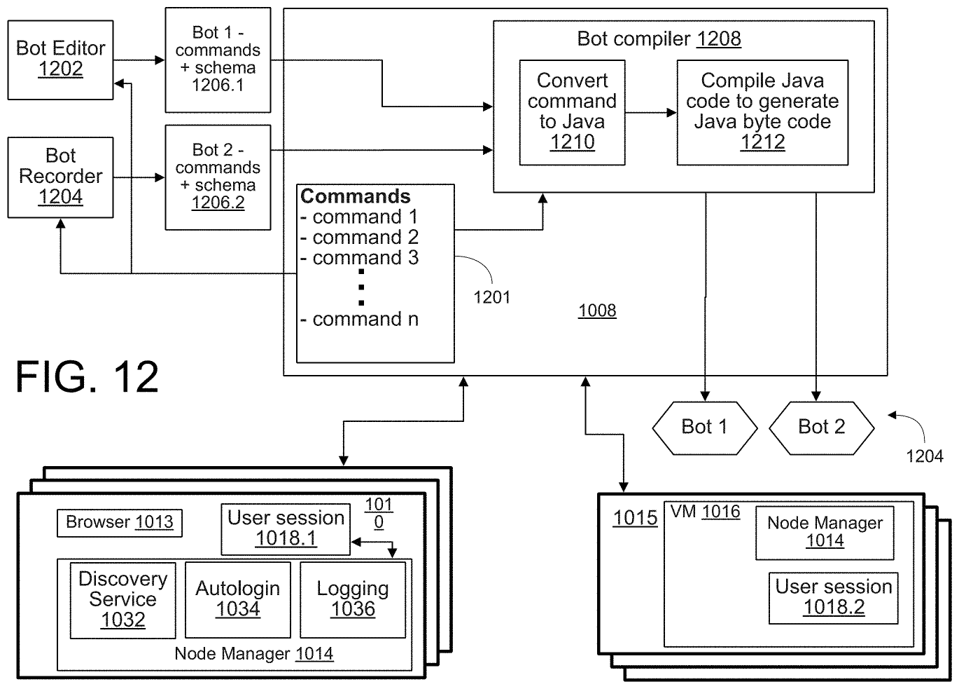

FIG. 12 illustrates yet another embodiment of the RPA system 1000 of FIG. 10 configured to provide platform independent sets of task processing instructions for bots 1004. Two bots 1004, bot 1 and bot 2 are shown in FIG. 12. Each of bots 1 and 2 are formed from one or more commands 1201, each of which specifies a user level operation with a specified application program, or a user level operation provided by an operating system. Sets of commands 1206.1 and 1206.2 may be generated by bot editor 1202 and bot recorder 1204, respectively, to define sequences of application level operations that are normally performed by a human user. The bot editor 1202 may be configured to combine sequences of commands 1201 via an editor. The bot recorder 1204 may be configured to record application level operations performed by a user and to convert the operations performed by the user to commands 1201. The sets of commands 1206.1 and 1206.2 generated by the editor 1202 and the recorder 1204 can include command(s) and schema for the command(s), where the schema defines the format of the command(s). The format of a command can, such as, includes the input(s) expected by the command and their format. For example, a command to open a URL might include the URL, a user login, and a password to login to an application resident at the designated URL.

The control room 1008 operates to compile, via compiler 1208, the sets of commands generated by the editor 1202 or the recorder 1204 into platform independent executables, each of which is also referred to herein as a bot JAR (Java ARchive) that perform application level operations captured by the bot editor 1202 and the bot recorder 1204. In the embodiment illustrated in FIG. 12, the set of commands 1206, representing a bot file, can be captured in a JSON (JavaScript Object Notation) format which is a lightweight data-interchange text-based format. JSON is based on a subset of the JavaScript Programming Language Standard ECMA-262 3rd Edition-December 1999. JSON is built on two structures: (i) a collection of name/value pairs; in various languages, this is realized as an object, record, struct, dictionary, hash table, keyed list, or associative array, (ii) an ordered list of values which, in most languages, is realized as an array, vector, list, or sequence. Bots 1 and 2 may be executed on devices 1010 and/or 1015 to perform the encoded application level operations that are normally performed by a human user.

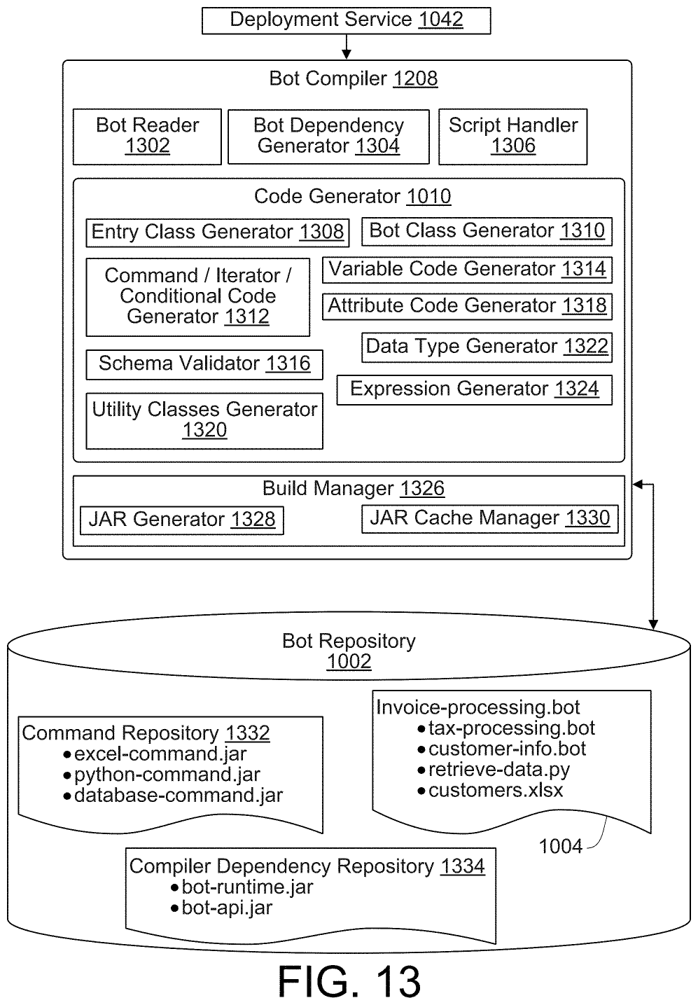

FIG. 13 is a block diagram illustrating details of one embodiment of the bot compiler 1208 illustrated in FIG. 12. The bot compiler 1208 accesses one or more of the bots 1004 from the data storage 1002, which can serve as bot repository, along with commands 1201 that are contained in a command repository 1332. The bot compiler 1008 can also access compiler dependency repository 1334. The bot compiler 1008 can operate to convert each command 1201 via code generator module 1210 to an operating system independent format, such as a Java command. The bot compiler 1008 then compiles each operating system independent format command into byte code, such as Java byte code, to create a bot JAR. The convert command to Java module 1210 is shown in further detail in in FIG. 13 by JAR generator 1328 of a build manager 1326. The compile Java code to generate Java byte code module 1212 can be provided by the JAR generator 1328. In one embodiment, a conventional Java compiler, such as javac from Oracle Corporation, may be employed to generate the bot JAR (artifacts). As will be appreciated by those skilled in the art, an artifact in a Java environment includes compiled code along with other dependencies and resources required by the compiled code. Such dependencies can include libraries specified in the code and other artifacts. Resources can include web pages, images, descriptor files, other files, directories and archives.

As noted in connection with FIG. 12, deployment service 1042 can be responsible to trigger the process of bot compilation and then once a bot has compiled successfully, to execute the resulting bot JAR on selected devices 1010 and/or 1015. The bot compiler 1208 can comprises a number of functional modules that, when combined, generate a bot 1004 in a JAR format. A bot reader 1302 loads a bot file into memory with class representation. The bot reader 1302 takes as input a bot file and generates an in-memory bot structure. A bot dependency generator 1304 identifies and creates a dependency graph for a given bot. It includes any child bot, resource file like script, and document or image used while creating a bot. The bot dependency generator 1304 takes, as input, the output of the bot reader 1302 and provides, as output, a list of direct and transitive bot dependencies. A script handler 1306 handles script execution by injecting a contract into a user script file. The script handler 1306 registers an external script in manifest and bundles the script as a resource in an output JAR. The script handler 1306 takes, as input, the output of the bot reader 1302 and provides, as output, a list of function pointers to execute different types of identified scripts like Python, Java, VB scripts.

An entry class generator 1308 can create a Java class with an entry method, to permit bot execution to be started from that point. For example, the entry class generator 1308 takes, as an input, a parent bot name, such “Invoice-processing.bot” and generates a Java class having a contract method with a predefined signature. A bot class generator 1310 can generate a bot class and orders command code in sequence of execution. The bot class generator 1310 can take, as input, an in-memory bot structure and generates, as output, a Java class in a predefined structure. A Command/Iterator/Conditional Code Generator 1312 wires up a command class with singleton object creation, manages nested command linking, iterator (loop) generation, and conditional (If/Else If/Else) construct generation. The Command/Iterator/Conditional Code Generator 1312 can take, as input, an in-memory bot structure in JSON format and generates Java code within the bot class. A variable code generator 1314 generates code for user defined variables in the bot, maps bot level data types to Java language compatible types, and assigns initial values provided by user. The variable code generator 1314 takes, as input, an in-memory bot structure and generates Java code within the bot class. A schema validator 1316 can validate user inputs based on command schema and includes syntax and semantic checks on user provided values. The schema validator 1316 can take, as input, an in-memory bot structure and generates validation errors that it detects. The attribute code generator 1318 can generate attribute code, handles the nested nature of attributes, and transforms bot value types to Java language compatible types. The attribute code generator 1318 takes, as input, an in-memory bot structure and generates Java code within the bot class. A utility classes generator 1320 can generate utility classes which are used by an entry class or bot class methods. The utility classes generator 1320 can generate, as output, Java classes. A data type generator 1322 can generate value types useful at runtime. The data type generator 1322 can generate, as output, Java classes. An expression generator 1324 can evaluate user inputs and generates compatible Java code, identifies complex variable mixed user inputs, inject variable values, and transform mathematical expressions. The expression generator 1324 can take, as input, user defined values and generates, as output, Java compatible expressions.

The JAR generator 1328 can compile Java source files, produces byte code and packs everything in a single JAR, including other child bots and file dependencies. The JAR generator 1328 can take, as input, generated Java files, resource files used during the bot creation, bot compiler dependencies, and command packages, and then can generate a JAR artifact as an output. The JAR cache manager 1330 can put a bot JAR in cache repository so that recompilation can be avoided if the bot has not been modified since the last cache entry. The JAR cache manager 1330 can take, as input, a bot JAR.

In one or more embodiment described herein command action logic can be implemented by commands 1201 available at the control room 1008. This permits the execution environment on a device 1010 and/or 1015, such as exists in a user session 1018, to be agnostic to changes in the command action logic implemented by a bot 1004. In other words, the manner in which a command implemented by a bot 1004 operates need not be visible to the execution environment in which a bot 1004 operates. The execution environment is able to be independent of the command action logic of any commands implemented by bots 1004. The result is that changes in any commands 1201 supported by the RPA system 1000, or addition of new commands 1201 to the RPA system 1000, do not require an update of the execution environment on devices 1010, 1015. This avoids what can be a time and resource intensive process in which addition of a new command 1201 or change to any command 1201 requires an update to the execution environment to each device 1010, 1015 employed in a RPA system. Take, for example, a bot that employs a command 1201 that logs into an on-online service. The command 1201 upon execution takes a Uniform Resource Locator (URL), opens (or selects) a browser, retrieves credentials corresponding to a user on behalf of whom the bot is logging in as, and enters the user credentials (e.g. username and password) as specified. If the command 1201 is changed, for example, to perform two-factor authentication, then it will require an additional resource (the second factor for authentication) and will perform additional actions beyond those performed by the original command (for example, logging into an email account to retrieve the second factor and entering the second factor). The command action logic will have changed as the bot is required to perform the additional changes. Any bot(s) that employ the changed command will need to be recompiled to generate a new bot JAR for each changed bot and the new bot JAR will need to be provided to a bot runner upon request by the bot runner. The execution environment on the device that is requesting the updated bot will not need to be updated as the command action logic of the changed command is reflected in the new bot JAR containing the byte code to be executed by the execution environment.

The embodiments herein can be implemented in the general context of computer-executable instructions, such as those included in program modules, being executed in a computing system on a target, real or virtual, processor. Generally, program modules include routines, programs, libraries, objects, classes, components, data structures, etc. that perform particular tasks or implement particular abstract data types. The program modules may be obtained from another computer system, such as via the Internet, by downloading the program modules from the other computer system for execution on one or more different computer systems. The functionality of the program modules may be combined or split between program modules as desired in various embodiments. Computer-executable instructions for program modules may be executed within a local or distributed computing system. The computer-executable instructions, which may include data, instructions, and configuration parameters, may be provided via an article of manufacture including a computer readable medium, which provides content that represents instructions that can be executed. A computer readable medium may also include a storage or database from which content can be downloaded. A computer readable medium may further include a device or product having content stored thereon at a time of sale or delivery. Thus, delivering a device with stored content, or offering content for download over a communication medium, may be understood as providing an article of manufacture with such content described herein.

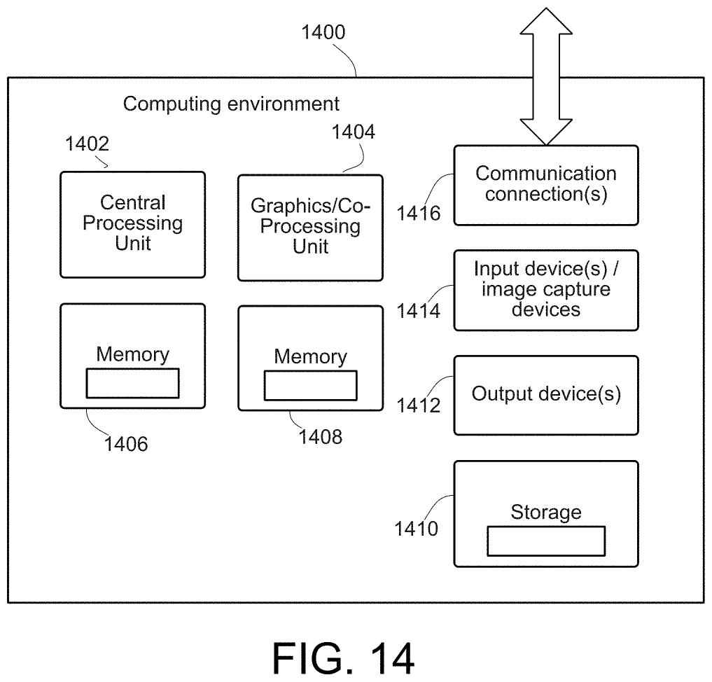

FIG. 14 illustrates a block diagram of an exemplary computing environment 1400 for an implementation of an RPA system, such as the RPA systems disclosed herein. The embodiments described herein may be implemented using the exemplary computing environment 1400. The exemplary computing environment 1400 includes one or more processing units 1402, 1404 and memory 1406, 1408. The processing units 1402, 1406 execute computer-executable instructions. Each of the processing units 1402, 1406 can be a general-purpose central processing unit (CPU), processor in an application-specific integrated circuit (ASIC) or any other type of processor. For example, as shown in FIG. 14, the processing unit 1402 can be a CPU, and the processing unit can be a graphics/co-processing unit (GPU). The tangible memory 1406, 1408 may be volatile memory (e.g., registers, cache, RAM), non-volatile memory (e.g., ROM, EEPROM, flash memory, etc.), or some combination of the two, accessible by the processing unit(s). The hardware components may be standard hardware components, or alternatively, some embodiments may employ specialized hardware components to further increase the operating efficiency and speed with which the RPA system operates. The various components of exemplary computing environment 1400 may be rearranged in various embodiments, and some embodiments may not require nor include all of the above components, while other embodiments may include additional components, such as specialized processors and additional memory.

The exemplary computing environment 1400 may have additional features such as, for example, tangible storage 1410, one or more input devices 1414, one or more output devices 1412, and one or more communication connections 1416. An interconnection mechanism (not shown) such as a bus, controller, or network can interconnect the various components of the exemplary computing environment 1400. Typically, operating system software (not shown) provides an operating system for other software executing in the exemplary computing environment 1400, and coordinates activities of the various components of the exemplary computing environment 1400.

The tangible storage 1410 may be removable or non-removable, and includes magnetic disks, magnetic tapes or cassettes, CD-ROMs, DVDs, or any other medium which can be used to store information in a non-transitory way, and which can be accessed within the computing system 1400. The tangible storage 1410 can store instructions for the software implementing one or more features of a PRA system as described herein.

The input device(s) or image capture device(s) 1414 may include, for example, one or more of a touch input device such as a keyboard, mouse, pen, or trackball, a voice input device, a scanning device, an imaging sensor, touch surface, or any other device capable of providing input to the exemplary computing environment 1400. For multimedia embodiment, the input device(s) 1414 can, for example, include a camera, a video card, a TV tuner card, or similar device that accepts video input in analog or digital form, a microphone, an audio card, or a CD-ROM or CD-RW that reads audio/video samples into the exemplary computing environment 1400. The output device(s) 1412 can, for example, include a display, a printer, a speaker, a CD-writer, or any another device that provides output from the exemplary computing environment 1400.

The one or more communication connections 1416 can enable communication over a communication medium to another computing entity. The communication medium conveys information such as computer-executable instructions, audio or video input or output, or other data. The communication medium can include a wireless medium, a wired medium, or a combination thereof.

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. In one embodiment, the computer readable medium is non-transitory. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method for providing software automation, comprising:
examining a conversation provided in a communication platform for a software automation objective;
retrieving a virtual agent automation dialog relevant to the software automation objective;
initiating presentation of the virtual agent automation dialog within the communication platform to acquire configuration parameters; and
activating a software automation process in accordance with the configuration parameters to provide the software automation objective.

2. A computer-implemented method as recited in claim 1, wherein the communication platform is a communication platform supporting text and voice communications.

3. A computer-implemented method as recited in claim 1, wherein the virtual agent automation dialog comprises a chat session including a plurality of text-based messages.

4. A computer-implemented method as recited in claim 3, wherein the presenting of the virtual agent automation dialog comprises:
iteratively presenting the plurality of text-based messages in the chat session to obtain text responses; and
determining the configuration parameters based on the text responses.

5. A computer-implemented method as recited in claim 1, wherein the communication platform is a unified communication and collaboration platform.

6. A computer-implemented method as recited in claim 1, wherein the retrieving comprises:
generating the virtual agent automation dialog to acquire the configuration parameters.

7. A computer-implemented method as recited in claim 1, wherein the computer-implemented method comprises:
identifying the software automation process to be activated from a plurality of available software automation processes based on the software automation objective

8. A computer-implemented method as recited in claim 1, wherein the computer-implemented method comprises:
identifying the software automation process to be activated from a plurality of available software automation processes based on the virtual agent automation dialog.

9. A computer-implemented method as recited in claim 1, wherein the examining of the conversation uses at least natural language processing.

10. A computer-implemented method for providing software automation, comprising:
examining a conversation provided in a communication platform for a software automation objective;
identifying a software automation process associated with the software automation objective;
retrieving a parameter set for the identified software automation process;
forming at least one dialog message to request parameter data for the parameter set for the identified software automation process;
inserting the at least one dialog message into the conversation provided in the communication platform;
examining the conversation provided in the communication platform for a response to the at least one dialog message;
extracting the parameter data from the response to the at least one dialog message; and
requesting execution of the identified software automation process in accordance with the parameter data from the response to the at least one dialog message.

11. A computer-implemented method as recited in claim 10, wherein the retrieving of the parameter set for the identified software automation process comprises:
identifying an Application Programming Interface (API) associated with the identified software automation process; and
accessing the API associated with the identified software automation process to retrieve the parameter set for the identified software automation process.

12. A computer-implemented method as recited in claim 11, wherein the requesting execution of the identified software automation process in accordance with the parameter data comprises:
accessing the API associated with the identified software automation process to request execution of the identified software automation process in accordance with the parameter data from the response to the at least one dialog message.

13. A computer-implemented method as recited in claim 10, wherein the computer implemented method comprises:
recognizing, subsequent to the requesting execution of the identified software automation process, that the identified software automation process has completed execution;
retrieving status data from the identified software automation process pertaining to its execution;
forming a status message pertaining to the execution of the identified software automation process and including at least a portion of the status data; and
inserting the status message into the conversation provided in the communication platform.

14. A computer-implemented method as recited in claim 10, wherein the conversation is between a requestor and a virtual agent.

15. A computer-implemented method as recited in claim 14, wherein the computer implemented method comprises:
recognizing, subsequent to the requesting execution of the identified software automation process, that the identified software automation process has completed execution;
retrieving status data from the identified software automation process pertain to its execution;
forming a status message pertaining to the execution of the identified software automation process; and
electronically transmitting the status message to the requestor.

16. A computer-implemented method as recited in claim 10, wherein the conversation is text-based.

17. A computer-implemented method as recited in claim 10, wherein the conversation is verbal-based or speech-based.

18. A computer-implemented method as recited in claim 10, wherein the examining of the conversation comprises:
providing at least a portion of the conversation to an artificial intelligence platform; and
receiving from the artificial intelligence platform an indication of the software automation objective of the conversation.

19. A computer-implemented method as recited in claim 18, wherein the identifying of the software automation process associated with the software automation objective comprises:
mapping the software automation objective to the software automation process.

20. A computer-implemented system for facilitating conversational user interaction between a communication platform and a robotic process automation system, the computer-implemented system comprising:
a communication platform interface to receive communication within the communication platform associated with a virtual digital assistant;
an artificial intelligence (AI) platform interface to provide the received communication to an AI evaluation platform and to receive evaluation feedback from the AI evaluation platform;
a plurality of dialogs used with or by the virtual digital assistant to support user access to the robotic process automation system; and
a conversational control module configured to:
provide the received communication, received via the communication platform interface, to the AI platform interface;
receive the evaluation feedback from the AI platform interface;
select at least one dialog from the plurality of dialogs based on evaluation feedback;
identify a software automation process associated with the received communication, the evaluation feedback and/or the selected dialog;
invoke the selected dialog with or by the virtual digital assistant to acquire user parameter data for use with the identified software automation process; and
activate the identified software automation process based on at least a portion of the acquired user parameter data.

21. A computer-implemented system as recited in claim 20, wherein the communication platform is a unified communication platform supporting at least text and voice communication.

22. A computer-implemented system as recited in claim 20, wherein the conversational control module configured to:
subsequently update the virtual digital assistant with status information regarding the identified software automation process.

23. A computer-implemented system as recited in claim 20, wherein the received communication is with respect to a user, and
wherein the conversational control module configured to:
require the user to have assess privileges to the identified software automation process at least before the identified software automation process is activated.

24. A non-transitory computer readable medium including at least computer program code tangible stored thereon for providing software automation, the computer readable medium comprising:
computer program code for examining a conversation provided in a communication platform for a software automation objective;
computer program code for retrieving a virtual agent automation dialog relevant to the software automation objective;
computer program code for initiating presentation of the virtual agent automation dialog within the communication platform to acquire configuration parameters; and
computer program code for activating a software automation process in accordance with the configuration parameters to provide the software automation objective.

25. A non-transitory computer readable medium including at least computer program code tangible stored thereon for providing software automation, the computer readable medium comprising:
computer program code for examining a conversation provided in a communication platform for a software automation objective;
computer program code for identifying a software automation process associated with the software automation objective;
computer program code for retrieving a parameter set for the identified software automation process;
computer program code for forming at least one dialog message to request parameter data for the parameter set for the identified software automation process;
computer program code for inserting the at least one dialog message into the conversation provided in the communication platform;
computer program code for examining the conversation provided in the communication platform for a response to the at least one dialog message;
computer program code for extracting the parameter data from the response to the at least one dialog message; and
computer program code for requesting execution of the identified software automation process in accordance with the parameter data from the response to the at least one dialog message.
